(19) United States
(12) Patent Application Publication
(10) Pub. No.: US 2025/0375890 A1
(43) Pub. Date: Dec. 11, 2025

(54) ROBOT APPARATUS, CONTROL METHOD, AND STORAGE MEDIUM

(71) Applicant: CANON KABUSHIKI KAISHA, Tokyo (JP)

(72) Inventors: HIROFUMI ONISHI, Kanagawa (JP); HIROTO MIZOHANA, Tokyo (JP)

(21) Appl. No.: 19/220,818

(22) Filed: May 28, 2025

(30) Foreign Application Priority Data
Jun. 6, 2024 (JP) 2024-092169

(51) Int. Cl. B25J 9/16

(52) U.S. Cl. CPC B25J 9/1697; B25J 9/1687; B25J 9/1692

(57) ABSTRACT

A robot apparatus includes a robot with an imaging unit and a control unit that operates at a plurality of teaching points, a processing unit that executes visual servoing based on a reference image and outputs a control signal for controlling the robot in a predetermined section, and a mode selection unit that selects one of a plurality of operation modes as an operation mode of the robot at each of the teaching points, wherein in a case where the mode selection unit selects a first operation mode, the control unit moves the robot to the teaching point and causes the imaging unit to acquire the reference image, and in a case where the mode selection unit selects a second operation mode, the control unit moves the robot to the teaching point and controls the robot in the predetermined section based on the control signal.

### BACKGROUND

### Field

The present disclosure relates to a robot apparatus, a control method, and a storage medium.

### Description of the Related Art

In recent years, visual servoing has been used in robotic assembly machines as a technique for correcting the position and posture of a robot by using images. The visual servoing is a technology where a reference image that represents a goal state is set in advance, and the position and posture of a robot are corrected such that the captured image matches the reference image.

To acquire a reference image for use in the visual servoing, a worker needs to manually move the robot to a target position using a teaching pendant or the like and capture the image. For this reason, as the number of required reference images increases, the worker's workload will also increase.

For easy acquirement of a reference image, it is conceivable that a robot automatically acquires a reference image based om a robot program. According to this method, there may occur a mixture of points where visual servoing can be executed and points where a reference image is acquired. In this case, it is considered that work efficiency will be improved if it is possible to easily switch an operation between executing visual servoing to check the operation and automatically acquiring a reference image. For example, Japanese Patent Application Laid-Open No. 2015-157341 discusses a method of switching an operation between visual servoing and impedance control to perform the operation of a robot.

### SUMMARY

According to an aspect of the present disclosure, a robot apparatus includes a robot including an imaging unit and a control unit and configured to operate at a plurality of teaching points under an instruction provided by the control unit, a processing unit configured to execute visual servoing based on a reference image that is an image representing a goal state of the robot and a captured image acquired by the imaging unit driven to each of the plurality of teaching points and output a control signal for controlling the robot in a predetermined section, and a mode selection unit configured to select one of a plurality of operation modes as an operation mode of the robot at each of the plurality of teaching points, wherein in a case where the mode selection unit selects a first operation mode as the operation mode from the plurality of operation modes, the control unit moves the robot to the teaching point and causes the imaging unit to acquire the reference image, and wherein in a case where the mode selection unit selects a second operation mode as the operation mode from the plurality of operation modes, the control unit moves the robot to the teaching point and controls the robot in the predetermined section based on the control signal.

Further features of the present disclosure will become apparent from the following description of exemplary embodiments with reference to the attached drawings.

### BRIEF DESCRIPTION OF THE DRAWINGS

FIG. 1 is a schematic diagram of a robot apparatus according to a first exemplary embodiment.

FIG. 2 is a block diagram illustrating a control system of the robot apparatus according to the first exemplary embodiment.

FIG. 3 is a flowchart illustrating a process by the control system of the robot apparatus according to the first exemplary embodiment.

FIG. 4 is a flowchart of an operation adjustment process by the robot apparatus according to the first exemplary embodiment.

FIG. 5 is a diagram illustrating a user interface of an input device according to a second exemplary embodiment.

FIG. 6 is a flowchart of an operation adjustment process by a robot apparatus according to the second exemplary embodiment.

### DESCRIPTION OF THE EMBODIMENTS

Exemplary embodiments described below are intended to embody the technical ideas of the present disclosure, and are not intended to limit the present disclosure. The sizes and positional relationships of the components illustrated in each drawing may be exaggerated to clarify the description. In the following description, the same components are designated by the same reference numerals, and duplicated description thereof may be omitted.

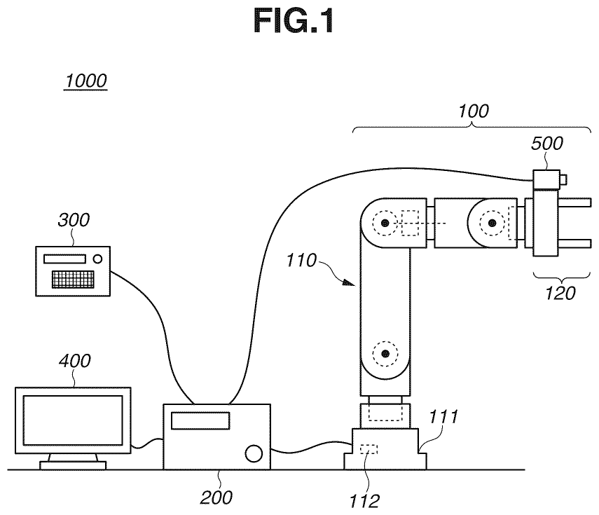

A first exemplary embodiment will now be described. FIG. 1 is a schematic diagram of a robot apparatus 1000 according to the first exemplary embodiment. The robot apparatus 1000 includes a robot 100, a robot control unit 112, a control device 200, an input device 300, a display device 400, and an imaging device 500. The robot control unit 112, the input device 300, the display device 400, and the imaging device 500 are connected to the control device 200.

The control device 200 is a device that controls the operation of the robot 100. The input device 300 is a teaching pendant, for example, which is operated by a user to input various types of information. The display device 400 is a monitor, for example, which can display various images. The imaging device 500 is a two-dimensional camera such as a digital camera, for example, which can capture an image of a subject to acquire two-dimensional image information. The imaging device 500 is not limited to the above example, and may be a three-dimensional camera, for example.

The robot 100 is an industrial robot, for example, which includes a robot arm 110, a robot hand 120, and the imaging device 500. The robot 100 is provided in a production line and used to manufacture articles. The work of manufacturing articles includes gripping a first workpiece with the robot hand 120 and using the robot arm 110 to assemble the first workpiece to a second workpiece, for example. The work of manufacturing articles includes conveyance, assembly, machining, and coating. The machining includes cutting, grinding, polishing, and sealing, for example. In these operations, using the visual servoing of the present exemplary embodiment described below enables high-precision operations.

In the present exemplary embodiment, the robot arm 110 is a vertical articulated robot arm, and is fixed to a base 111. An end effector suitable for the work is attached to the robot arm 110. In the present exemplary embodiment, the robot hand 120 is attached to the leading end of the robot arm 110. The imaging device 500 is attached to the robot hand 120.

The robot control unit 112 provides operation instructions to the robot arm 110 and the robot hand 120. Specifically, based on each command value corresponding to each joint acquired from the control device 200, the robot control unit 112 drives and controls the motors of joints of the robot arm 110 and the actuator of the robot hand 120. The robot control unit 112 is arranged inside the base 111, for example.

The arrangement position of the robot control unit 112 is not limited to inside the base 111. For example, the robot control unit 112 may be arranged inside a housing of the control device 200. That is, the robot control unit 112 may be one of components of the robot arm 110 or one of components of the control device 200.

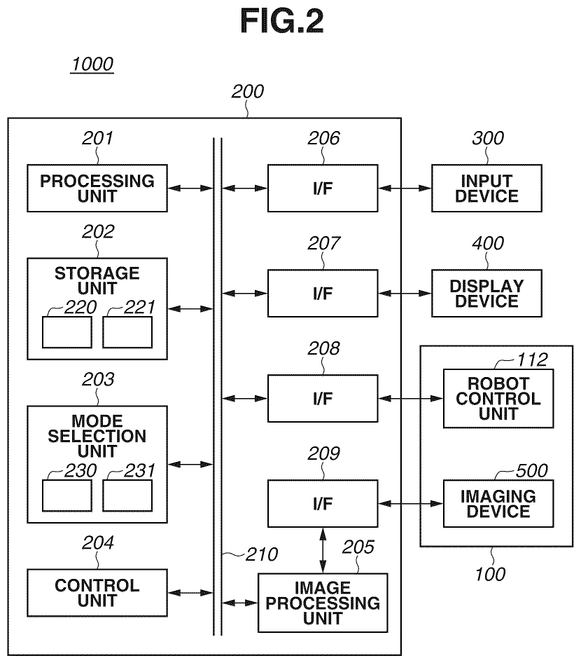

FIG. 2 is a block diagram illustrating the robot apparatus 1000 according to the present exemplary embodiment. The control device 200 has a processing unit 201, a storage unit 202, a mode selection unit 203, a control unit 204, an image processing unit 205, and a plurality of input/output interfaces (I/F) 206 to 209. The processing unit 201, the storage unit 202, the mode selection unit 203, the control unit 204, the image processing unit 205, and the interfaces 206 to 208 are connected via a bus 210. The input device 300 is connected to the interface 206, the display device 400 is connected to the interface 207, the robot control unit 112 is connected to the interface 208, and the image processing unit 205 and the imaging device 500 are connected to the interface 209.

The storage unit 202 stores a reference image 220 representing a goal state of visual servoing, and a robot program 221 that is executed for controlling the operation of the robot 100. The robot program 221 is a program that may execute the visual servoing. Identification information can be provided to the reference images 220 so that even if there is a plurality of locations where the visual servoing is to be executed, the reference images 220 can be distinguished from one another and used. The identification information is an image file name, for example. The reference image 220 is not limited to an image file, and can be numerical data.

The mode selection unit 203 changes the execution state related to the operation of the visual servoing of the robot program 221. The mode selection unit 203 stores execution information 230 about the visual servoing and execution information 231 about an imaging and saving process described below. The execution information 230 and the execution information 231 are binary variables, for example. The mode selection unit 203 may determine whether the reference image 220 is stored in the storage unit 202, and change the execution information 230 and 231 based on the determination result. For example, in a case where the reference image 220 is stored in the storage unit 202, the visual servoing may be turned on and the imaging and saving process may be turned off. In a case where the reference image 220 is not stored in the storage unit 202, the visual servoing may be turned off and the imaging and saving process may be turned on.

The processing unit 201 performs arithmetic processing of the robot program 221 in the storage unit 202 based on the execution information 230 and 231 about the mode selection unit 203. The processing unit 201 can acquire angle information about joints of the robot arm 110 and position information of the robot hand 120 from the robot control unit 112 via the interface 208 and the bus 210.

The control unit 204 acquires robot control amount from the processing unit 201, converts the robot control amount into command values corresponding to the joints of the robot arm 110, and outputs the command values to the robot control unit 112 via the bus 210 and the interface 208.

The image processing unit 205 performs image processing in response to a command from the processing unit 201, and calculates a reference image feature amount and a current image feature amount. The image feature amounts include calculated values of feature points of sides and corners of an imaged object, for example. The image processing unit 205 can display the image processing result on the display device 400 via the bus 210 and the interface 207. The image processing unit 205 may directly communicate with the processing unit 201 instead of via the bus 210. The image processing unit 205 need not be located internal to the control device 200, and may be located external to the control device 200.

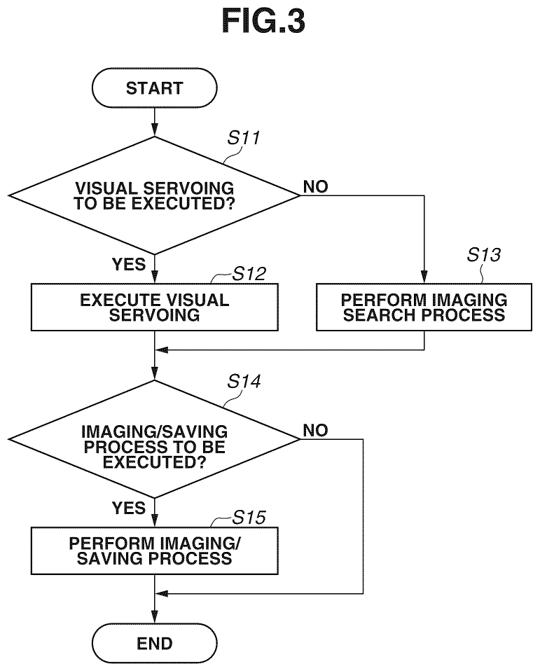

FIG. 3 is a flowchart illustrating a calculation process performed by the processing unit 201 according to the present exemplary embodiment based on the robot program 221.

In step S11, the processing unit 201 acquires the execution information 230 from the mode selection unit 203 and then determines whether to execute the control of a predetermined section of the robot 100 based on position control (first control) or based on a control signal calculated by executing the visual servoing (second control). In a case where the visual servoing is to be executed (YES in step S11), the process proceeds to step S12. In a case where the visual servoing is not to be executed (NO in step S11), the process proceeds to step S13.

In step S12, the processing unit 201 executes the visual servoing. The visual servoing is a process of acquiring a reference image feature amount and a current image feature amount from the image processing unit 205 at predetermined time intervals (for example, 30 ms) and calculating a robot control amount from the reference image feature amount and current image feature amount at predetermined time intervals (for example, 2 ms).

The image processing by the image processing unit 205 involves acquiring the reference image 220 from the storage unit 202, acquiring captured images from the imaging device 500 via the interface 209 at predetermined time intervals (for example, 30 ms), calculating a reference image feature amount from the reference image 220, and calculating a current image feature amount from the captured images. The processing unit 201 calculates a robot control value at predetermined time intervals (for example, 2 ms) until the visual servoing converges, and outputs the same to the control unit 204 as a control signal. Accordingly, the position and posture of the robot 100 can be corrected. After execution of step S12, the process proceeds to step S14.

In step S13, the processing unit 201 executes an imaging search process. The imaging search process is a process for calculating the robot control amount by using a relative control amount or a teaching point of a movement destination set in the robot program 221, that is, by controlling positions. For example, the teaching point may be a value obtained in advance by simulation or the like. If the convergence position of the visual servoing has already been obtained, the movement destination can be set to the same coordinates as the convergence position of the visual servoing so that robot control equivalent to the visual servoing can be performed. After execution of step S13, the process proceeds to step S14.

In step S14, the processing unit 201 acquires the execution information 231 from the mode selection unit 203 and determines whether to execute the imaging and saving process. If the imaging and saving process is to be executed (YES in step S14), the process proceeds to step S15. If the imaging and saving process is not to be executed (NO in step S14), the program ends.

In step S15, the processing unit 201 executes the imaging and saving process. The imaging and saving process is a process in which the imaging device 500 captures and acquires an image, and records the image as a reference image 220 in the storage unit 202 via the interface 209, the image processing unit 205, and the bus 210. In this process, an image acquired by the imaging device 500 may be converted into a reference image feature amount by the image processing unit 205, and the resultant image may be recorded as the reference image 220 in the storage unit 202. When execution of step S15 is completed, the program ends.

When steps S11 to S15 are executed, the robot apparatus 1000 has four operation modes depending on whether the visual servoing is to be performed and whether the imaging and saving process is to be performed. These modes are preferably used according to the purpose.

The first operation mode is a mode in which the visual servoing is not executed and the robot arm 110 is controlled by position control to execute the imaging and saving process, which is used in acquiring a reference image, for example. The second operation mode is a mode in which the visual servoing is executed and the imaging and saving process is not executed.

For example, the second operation mode is used when the robot 100 controlled by the visual servoing performs workpiece assembly and the operation of the robot 100 is checked. In the third operation mode, the visual servoing and the imaging and saving process are both executed. In the fourth operation mode, both the visual servoing and the execute imaging and saving process are not executed. The third and fourth operation modes will be described below.

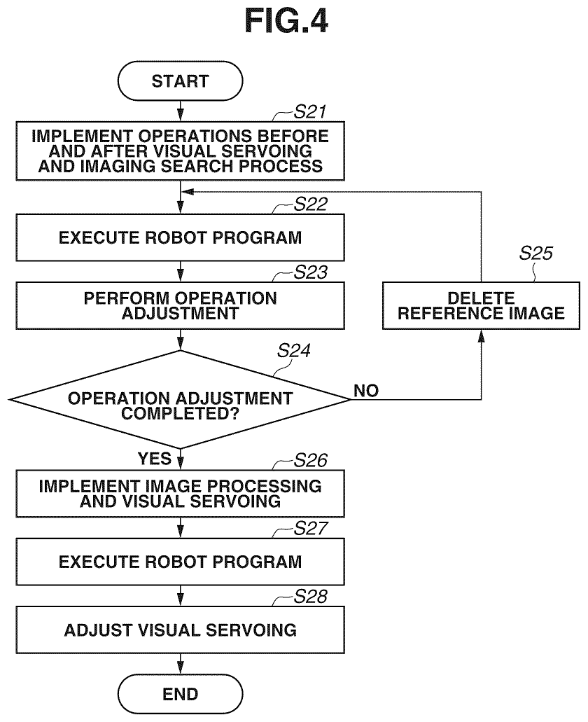

A procedure for adjusting the robot apparatus 1000 according to the present exemplary embodiment will be described with reference to FIG. 4.

In step S21, the operations of the robot program 221 are implemented before and after the visual servoing and the imaging search processing of the robot program 221. Unless the operations before and after the visual servoing are completed, the reference image 220 to be used cannot be determined, and image processing and control algorithms cannot be implemented. Accordingly, the visual servoing is implemented last in the robot program 221.

Instead of the incomplete visual servoing, the robot 100 can be controlled by the imaging search processing. After execution of step S21, the process proceeds to step S22.

In step S22, the robot program 221 is executed to check the operation of the robot 100. At this time, because the reference image 220 is not recorded in the storage unit 202, the mode selection unit 203 automatically changes the execution information 230 and 231, and the robot program 221 is executed with the visual servoing turned off and the imaging and saving process turned on. As a result, the incomplete visual servoing is not executed, and the reference image 220 is automatically acquired and recorded in the storage unit 202. After execution of step S22, the process proceeds to step S23.

In step S23, the operation of the robot 100 other than that of the visual servoing is adjusted based on the checking of operation of the robot 100 in step S22.

In step S24, it is determined whether the adjustment of the operation of the robot 100 other than the visual servoing is completed. If the adjustment is completed (YES in step S24), the process proceeds to step S26. If the adjustment is not completed and the operation of the robot 100 is to be checked again (NO in step S24), the process proceeds to step S25.

In step S25, the reference image 220 recorded in step S22 is deleted from the storage unit 202. After execution of step S25, the process proceeds to step S22. Subsequent steps S22 and S23 are executed, and the process proceeds to step S24. In step S22, the imaging and saving process can be executed again by the robot program 221.

In step S26, the reference image 220 acquired in step S22 is used to implement the image processing of the image processing unit 205 and the control algorithm of the visual servoing in the robot program 221. After execution of step S26, the process proceeds to step S27.

In step S27, the robot program 221 is executed. At this time, since the reference image 220 is recorded in the storage unit 202, the mode selection unit 203 automatically changes the execution information 230 and 231, and the robot program 221 is executed with the visual servoing turned on and the imaging and saving process turned off. As a result, all operations of the robot 100, including the visual servoing, are executed. After execution of step S27, the process proceeds to step S28.

In step S28, the visual servoing is adjusted by checking the operations of the robot 100 in step S27. When the execution of step S28 is completed, the adjustment is completed.

The aspects of the present exemplary embodiment are particularly useful in performing processes involving a large number of components and a large number of visual servo alignments. For example, if there are 100 locations where visual servoing is to be performed and takes 30 seconds at each location to obtain a reference image manually, the entire work will take about 50 minutes. In this case, if there are various teaching points at each location that require or do not require a reference image, the work will have to be done while the various teaching points are checked manually.

According to the present exemplary embodiment, the reference image 220 used for visual servoing can be automatically acquired, thereby reducing manual work as described above. At locations where the reference image 220 is not required, the operation of visual servoing can be checked without acquiring the reference image, which improves the efficiency of the adjustment of the robot 100.

A second exemplary embodiment will now be described. In the first exemplary embodiment, the robot program 221 can be executed by automatically switching an execution state between the two execution states. That is, the execution state in which the visual servoing is turned on and the imaging and saving process is turned off, or the execution state in which the visual servoing is turned off and imaging and saving process is turned on. In the present exemplary embodiment, these execution states are arbitrarily changed by a manual input from a user as described below. In particular, if the visual servoing and the imaging and saving process can be arbitrarily switched on and off, a robot program 221 can be executed with both the visual servoing and the imaging and saving process turned on (the above-described third operation mode) or both turned off (above-described fourth operation mode).

In the present exemplary embodiment, the mode selection unit 203 can change execution information 230 and 231 from the input device 300 via an interface 206 via a bus 210. The input device 300 is a teaching pendant, for example, which displays two switches on an operation screen, enabling a user to change execution information 230 by switching the visual servoing on and off with the first switch and to change execution information 231 by switching the imaging and saving process on and off with the second switch.

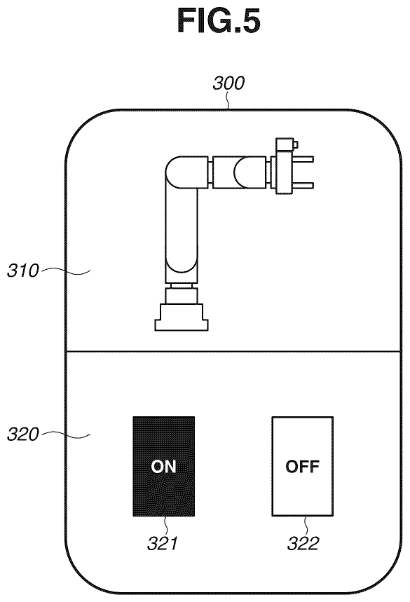

FIG. 5 illustrates an example of a user interface of the input device 300. The input device 300 is, for example, a touch panel display that includes a robot state display part 310 in an upper portion of the screen and an operation section 320 in lower portion of the screen. A first switch 321 and a second switch 322 are displayed in the operation section 320. The first switch 321 and the second switch 322 are turned on or off each time they are selected, with the current input state of each switch being indicated on the respective switch. The first switch 321 and the second switch 322 are not limited to touch switches, and can be, for example, toggle switches.

A processing unit 201 may change the execution information 230 and 231 of the mode selection unit 203 in response to the user's describing the specification of the mode in the robot program 221. For example, when the robot program 221 is operated to move each of the teaching points, a number to execute which mode may be specified in each operation. The method of switching via mode specification may be given a higher priority than switching via the first switch 321 and the second switch 322 described above. In this case, the processing unit 201 outputs the execution information 230 and 231 changed by the mode specification to the input device 300 via the bus 210 and the interface 206, and changes the indications on the first switch 321 and the second switch 322.

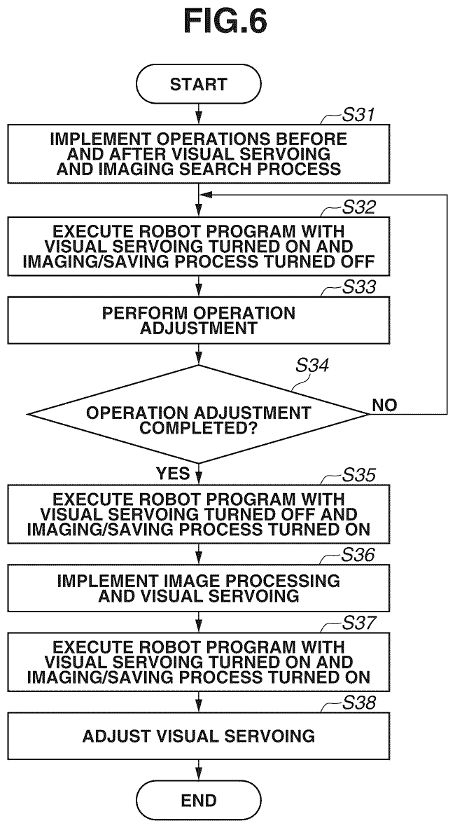

A procedure for adjusting the robot apparatus 1000 according to the present exemplary embodiment will be described with reference to FIG. 6. Description of steps similar to those in the flowchart of FIG. 4 described above will be omitted herein.

Step S31 is the same as step S21. After execution of step S31, the process proceeds to step S32.

In step S32, the robot program 221 is executed with the switch 321 and the switch 322 turned off. At this time, the robot program 221 is executed with both the visual servoing and the imaging and saving process turned off. After execution of step S32, the process proceeds to step S33.

Step S33 is the same as step S23. After execution of step S33, the process proceeds to step S34.

Step S34 is the same as step S24. If the adjustment is completed (YES in step S34), the process proceeds to step S35. If the adjustment is not completed and the operation of the robot 100 is to be checked again (NO in step S34), the process proceeds to step S32.

In step S35, the worker executes the robot program 221 with the switch 321 turned off and the switch 322 turned on. At this time, the robot program 221 is executed with the visual servoing turned off and the imaging and saving process turned on, so that the processing is the same as in step S22. After execution of step S35, the process proceeds to step S36.

Step S36 is the same as step S26. After execution of step S36, the process proceeds to step S37.

In step S37, the robot program 221 is executed with the switch 321 and the switch 322 turned on. At this time, the robot program 221 is executed with both the visual servoing and the imaging and saving process turned on, for example. While the reference image 220 has already been acquired in step S35, this setting is suitable for the case where the imaging and saving process is to be performed for future visual servo development. If it is not necessary to acquire the reference image 220, the robot program 221 may be executed with the switch 322 turned off. In this case, the processing is the same as in step S27. After execution of step S37, the process proceeds to step S38.

Step S38 is the same as step S28. When execution of step S28 is completed, the adjustment ends.

According to the present exemplary embodiment, both the visual servoing and the imaging and saving process can be turned off, so that unnecessary operations can be avoided at locations where the reference image 220 is not required and where checking of the operation of the visual servoing is not required.

Since both the visual servoing and the imaging and saving process can be turned on, it is possible to acquire images during visual servoing, and these images can be used as reference data for visual servo development.

A third exemplary embodiment will now be described. In the first exemplary embodiment, in the imaging and saving process in step S15 of FIG. 3, image capturing is performed (step S14) at the end point of the movement of the robot 100 (step S12 or S13) to acquire the reference image 220, but this is not seen to be limiting. For example, in steps S12 and S13, image capturing may be performed at predetermined intervals between the start and end of movement of a robot 100, and a group of acquired reference images may be used as reference images 220. In steps S12 and S13, video capturing may be performed between the start and end of movement of the robot 100, and images sampled from the video may be used as the reference images 220.

According to the present exemplary embodiment, images captured during movement of the robot 100 can be acquired as the reference images 220, and can be used as reference data for visual servoing development.

Each of the above-described exemplary embodiments merely represent examples of the present disclosure, and the technical scope of the present disclosure are not seen to be limited by these examples. The present disclosure can be carried out in various forms without departing from its technical idea or main features. For example, combinations of the elements of the above-described exemplary embodiments are also within the scope of the present disclosure.

The above-described exemplary embodiments can be modified as appropriate without departing from the scope of the technical concept. The disclosure herein includes not only what is described herein, but also all matters that can be understood from this specification and the drawings attached hereto.

A control program that executes the above-described control method and a computer-readable recording medium storing the control program are also included in exemplary embodiments of the present disclosure.

The present disclosure can also be implemented by a process in which a program for implementing one or more functions of the exemplary embodiments is supplied to a system or device via a network or a storage medium, and one or more processors in a computer of the system or device read and execute the program. The present disclosure can also be implemented by a circuit (for example, an application specific integrated circuits (ASIC)) for implementing one or more functions.

The disclosure of the exemplary embodiments includes the following configurations.

### Item 1

A robot apparatus including:
a robot, including an imaging unit and a control unit, configured to operate at a plurality of teaching points based on an instruction provided by the control unit;
a processing unit configured to execute visual servoing based on a reference image that is an image representing a goal state of the robot and a captured image acquired by the imaging unit driven to each of the plurality of teaching points and output a control signal for controlling the robot in a predetermined section; and
a mode selection unit configured to select one of a plurality of operation modes as an operation mode of the robot at each of the plurality of teaching points,
wherein in a case where the mode selection unit selects a first operation mode as the operation mode from the plurality of operation modes, the control unit moves the robot to the teaching point and causes the imaging unit to acquire the reference image, and
wherein in a case where the mode selection unit selects a second operation mode as the operation mode from the plurality of operation modes, the control unit moves the robot to the teaching point and controls the robot in the predetermined section based on the control signal.

### Item 2

The robot apparatus according to item 1,
wherein the plurality of operation modes further includes a third operation mode, and
wherein in a case where the mode selection unit selects the third operation mode as the operation mode from the plurality of operation modes, the control unit moves the robot to the teaching point and operates the robot in the predetermined section under control based on the control signal, and causes the imaging unit to acquire the reference image while the robot is operating in the predetermined section.

### Item 3

The robot apparatus according to item 1,
wherein the plurality of operation modes further includes a fourth operation mode, and
wherein in a case where the mode selection unit selects the fourth operation mode as the operation mode from the plurality of operation modes, the control unit moves the robot to the teaching point and does not perform control based on the control signal and does not cause the imaging unit to acquire the reference image.

### Item 4

The robot apparatus according to item 2, wherein the control unit causes the imaging unit to acquire a plurality of the reference images at predetermined intervals while the robot is operating in the predetermined section.

### Item 5

The robot apparatus according to item 1, further including a storage unit,
wherein in a case where the reference image corresponding to the teaching point is not stored in the storage unit, the mode selection unit selects the first operation mode as the operation mode from the plurality of operation modes.

### Item 6

The robot apparatus according to item 1, further including a storage unit,
wherein the mode selection unit selects the operation mode from the plurality of operation modes based on a program stored in the storage unit that controls operation of the robot.

### Item 7

The robot apparatus according to item 1, further including an input device,
wherein the mode selection unit selects the operation mode from the plurality of operation modes based on an operation performed on the input device.

### Item 8

The robot apparatus according to item 7,
wherein the input device is a touch panel, and
wherein a first switch and a second switch are displayed on the touch panel, the first switch used for selecting whether to operate the robot in the predetermined section under control based on the control signal, and the second switch used for selecting whether to cause the imaging unit to acquire the reference image.

### Item 9

A manufacturing method of an article, including manufacturing the article by using the robot apparatus according to item 1.

### Item 10

A method of controlling a robot apparatus including a robot, including an imaging unit and a control unit, configured to operate at a plurality of teaching points based on an instruction provided by the control unit, the method comprising:
executing visual servoing based on a reference image that is an image representing a goal state of the robot and a captured image acquired by the imaging unit driven to each of the plurality of teaching points;
   outputting a control signal for controlling the robot in a predetermined section; and
selecting one of a plurality of operation modes as an operation mode of the robot at each of the plurality of teaching points,
wherein, in a case a first operation mode is selected as the operation mode from the plurality of operation modes, the robot is moved to the teaching point and the imaging unit acquires the reference image, and
wherein, in a case where a second operation mode is selected as the operation mode from the plurality of operation modes, the robot is moved to the teaching point and the robot is controlled in the predetermined section based on the control signal.

### Item 11

A computer-readable recording medium storing a program for causing a computer to execute the method according to item 10.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-092169, filed Jun. 6, 2024, which is hereby incorporated by reference herein in its entirety.

What is claimed is:

1. A robot apparatus comprising:
a robot, including an imaging unit and a control unit, configured to operate at a plurality of teaching points based on an instruction provided by the control unit;
a processing unit configured to execute visual servoing based on a reference image that is an image representing a goal state of the robot and a captured image acquired by the imaging unit driven to each of the plurality of teaching points and output a control signal for controlling the robot in a predetermined section; and
a mode selection unit configured to select one of a plurality of operation modes as an operation mode of the robot at each of the plurality of teaching points,
wherein in a case where the mode selection unit selects a first operation mode as the operation mode from the plurality of operation modes, the control unit moves the robot to the teaching point and causes the imaging unit to acquire the reference image, and
wherein in a case where the mode selection unit selects a second operation mode as the operation mode from the plurality of operation modes, the control unit moves the robot to the teaching point and controls the robot in the predetermined section based on the control signal.

2. The robot apparatus according to claim 1,
wherein the plurality of operation modes further includes a third operation mode, and
wherein in a case where the mode selection unit selects the third operation mode as the operation mode from the plurality of operation modes, the control unit moves the robot to the teaching point, operates the robot in the predetermined section under control based on the control signal, and causes the imaging unit to acquire the reference image while the robot is operating in the predetermined section.

3. The robot apparatus according to claim 2, wherein the control unit causes the imaging unit to acquire a plurality of the reference images at predetermined intervals while the robot is operating in the predetermined section.

4. The robot apparatus according to claim 1,
wherein the plurality of operation modes further includes a fourth operation mode, and
wherein in a case where the mode selection unit selects the fourth operation mode as the operation mode from the plurality of operation modes, the control unit moves the robot to the teaching point, does not perform control based on the control signal, and does not cause the imaging unit to acquire the reference image.

5. The robot apparatus according to claim 1, further comprising a storage unit, wherein in a case where the reference image corresponding to the teaching point is not stored in the storage unit, the mode selection unit selects the first operation mode as the operation mode from the plurality of operation modes.

6. The robot apparatus according to claim 1, further comprising a storage unit, wherein the mode selection unit selects the operation mode from the plurality of operation modes based on a program stored in the storage unit that controls operation of the robot.

7. The robot apparatus according to claim 1, further comprising an input device, wherein the mode selection unit selects the operation mode from the plurality of operation modes based on an operation performed on the input device.

8. The robot apparatus according to claim 7,
wherein the input device is a touch panel, and
wherein a first switch and a second switch are displayed on the touch panel, the first switch used for selecting whether to operate the robot in the predetermined section under control based on the control signal and the second switch used for selecting whether to cause the imaging unit to acquire the reference image.

9. A manufacturing method of an article, comprising manufacturing the article by using the robot apparatus according to claim 1.

10. A method of controlling a robot apparatus including a robot, including an imaging unit and a control unit, configured to operate at a plurality of teaching points based on an instruction provided by the control unit, the method comprising:
executing visual servoing based on a reference image that is an image representing a goal state of the robot and a captured image acquired by the imaging unit driven to each of the plurality of teaching points;
outputting a control signal for controlling the robot in a predetermined section; and
selecting one of a plurality of operation modes as an operation mode of the robot at each of the plurality of teaching points,
wherein, in a case a first operation mode is selected as the operation mode from the plurality of operation modes, the robot is moved to the teaching point and the imaging unit acquires the reference image, and
wherein, in a case where a second operation mode is selected as the operation mode from the plurality of operation modes, the robot is moved to the teaching point and the robot is controlled in the predetermined section based on the control signal.

11. A computer-readable recording medium storing a program for causing a computer to execute the method according to claim 10.
